(19) United States
(12) Patent Application Publication
(10) Pub. No.: US 2017/0352974 A1
(43) Pub. Date: Dec. 7, 2017

(54) CONNECTOR

(71) Applicant: Sumitomo Wiring Systems, Ltd., Yokkaichi, Mie (JP)

(72) Inventor: Mizuho Fujimura, Yokkaichi, Mie (JP)

(21) Appl. No.: 15/542,664

(22) PCT Filed: Dec. 24, 2015
(86) PCT No.: PCT/JP2015/085923

§ 371 Date: Jul. 11, 2017

(30) Foreign Application Priority Data
Jan. 14, 2015 (JP) 2015-004990

(51) Int. Cl. H01R 13/42; H01R 13/514; H01R 13/629; H01R 13/05; H01R 13/641; H01R 13/627

(52) U.S. Cl. CPC H01R 13/42; H01R 13/641; H01R 13/6276; H01R 13/629; H01R 13/055; H01R 13/627; H01R 13/514; H01R 13/62927

(57) ABSTRACT

A connector includes a connector housing (10) with a cavity (15B), into which a terminal fitting (40) is to be inserted. The connector housing (10) is connectable to a mating connector. A retainer insertion opening (30) opens in a side surface of the connector housing (10) and in a direction intersecting an inserting direction of the terminal fitting (40). A retainer (50) can be inserted into the retainer insertion opening to lock the terminal fitting (40). The retainer (50) includes a thin plate (61) extending in an inserting direction of the retainer (50), a convex portion (70) on a lower surface of the thin plate (61) and a groove (71) in the convex portion (70). A projection (25) is provided on a rear part of a locking lance (20) in the cavity (15B) of the connector housing (10) and fits to the groove (71).

### TECHNICAL FIELD

A technique disclosed in this specification relates to a connector.

### BACKGROUND ART

In a connector of a side retainer type, a retainer insertion opening is formed in a side surface of a connector housing provided with a cavity, and a retainer provided with a locking protrusion capable of locking a step portion or the like of a terminal fitting is inserted through this retainer insertion opening. Here, if the connector has many contacts, particularly a plurality of cavities are arranged separately in a plurality of stages, the retainer is formed into a lattice shape in many cases. On the other hand, the miniaturization of connectors has been gradually required. If cavities are highly densely provided as a countermeasure for that, there is no more margin for forming the retainer into a lattice shape. In this case, the retainer has such a shape obtained by removing vertical frame pieces of a lattice, i.e. such a shape that horizontal arm portions corresponding to each stage of the cavities are arranged in parallel, only both ends thereof are coupled and locking protrusions are provided on each arm portion.

However, if the retainer is shaped as described above and, particularly, the arm portions are long, the arm portions may be curved and deformed since there is no support conventionally given by the vertical frame pieces. To solve such a problem, in a connector of Japanese Unexamined Patent Publication No. 2002-313473 (patent literature 1 below), guide grooves facing in a lateral direction are formed in front and rear surfaces of arm portions, whereas continuous ribs to be slidably fit into the guide grooves are formed on side walls of a retainer insertion opening facing the front and rear surfaces of the arm portions. By fitting the ribs on the connector housing side and the grooves on the retainer side in this way, the curving deformation of the retainer can be prevented.

### CITATION LIST

### Patent Literature

Patent Literature 1: Japanese Unexamined Patent Publication No. 2002-313473

### SUMMARY OF INVENTION

### Technical Problem

However, due to a request for further miniaturization, it may not be possible in some cases to form continuous guide grooves and ribs as in the connector shown in Japanese Unexamined Patent Publication No. 2002-313473 (above patent literature 1).

### Solution to Problem

A connector disclosed in this specification includes a connector housing provided with a cavity, into which a terminal fitting is to be insertable, and connectable to a mating connector, a retainer insertion opening provided in a side surface of the connector housing and open in a direction intersecting with an inserting direction of the terminal fitting, and a retainer to be inserted into the retainer insertion opening to lock the terminal fitting, wherein the retainer includes a thin plate portion extending in an inserting direction of the retainer, a convex portion provided on a lower surface of the thin plate portion and a groove portion provided in the convex portion, and a projection fittable to the groove portion is provided on a rear end part of a locking lance provided in the cavity of the connector housing.

According to this configuration, the deflection of the thin plate portion can be suppressed by fitting the groove portion and the projection even if continuous guide groove and rib cannot be formed.

The following configurations may be employed as embodiments of the connector disclosed in this specification.

The connector housing may be formed with the cavities such that terminal fittings of two or more sizes are arranged in a plurality of stages, a rear end part of the locking lance for locking a large-size terminal fitting larger than a smallest terminal fitting out of the terminal fittings may project more toward the retainer than the locking lances for locking the other terminal fittings, and a dimension of the thin plate portion in the inserting direction of the terminal fittings may be smaller than that of other parts of the retainer in the inserting direction of the terminal fittings to avoid the locking lance for locking the large-size terminal fitting.

According to this configuration, the use of such a structure is further preferable since the thin plate portion has a small width and is easily deflected.

### Effect

According to the connector disclosed in this specification, it is possible to suppress the curving deformation of a retainer also in a miniaturized connector.

### BRIEF DESCRIPTION OF DRAWINGS

FIG. 1 is a front view of a connector at a partial locking position according to an embodiment,

FIG. 2 is a right side view of the connector,

FIG. 3 is a section along in FIG. 1,

FIG. 4 is a section along IV-IV in FIG. 1,

FIG. 5 is a section along V-V in FIG. 1,

FIG. 6 is a partial enlarged section at a position V1 in FIG. 5,

FIG. 7 is a front view of the connector at a full locking position,

FIG. 8 is a section of a connector housing at the same position as in FIG. 3,

FIG. 9 is a section of the connector housing at the same position as in FIG. 4,

FIG. 10 is a section of the connector housing at the same position as in FIG. 5,

FIG. 11 is a perspective view of the connector housing,

FIG. 12 is a perspective view of the connector housing,

FIG. 13 is a section along XIII-XIII in FIG. 12,

FIG. 14 is a front view of a side retainer,

FIG. 15 is a plan view of the side retainer, and

FIG. 16 is a perspective view of the side retainer.

### EMBODIMENT OF INVENTION

### Embodiment

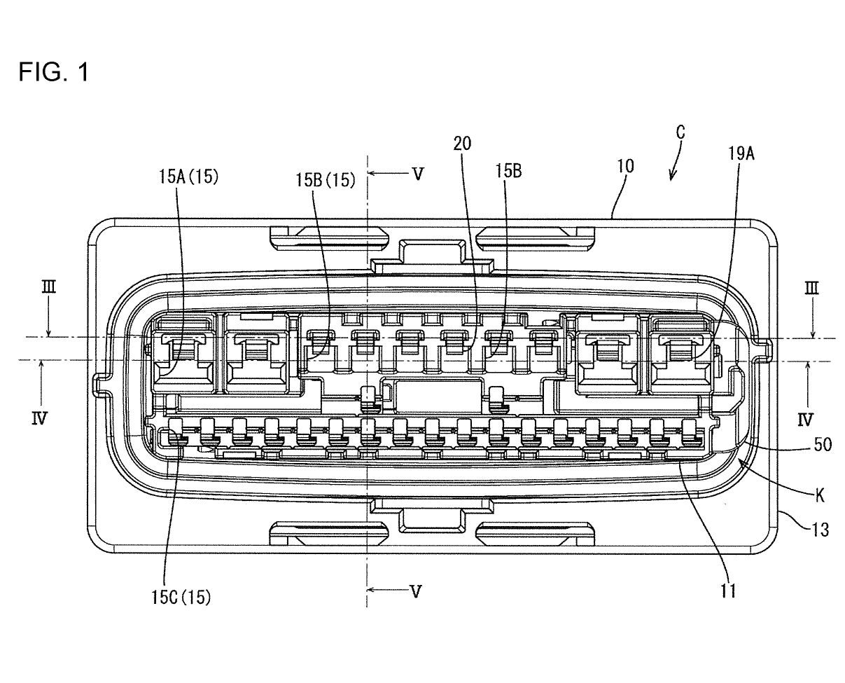

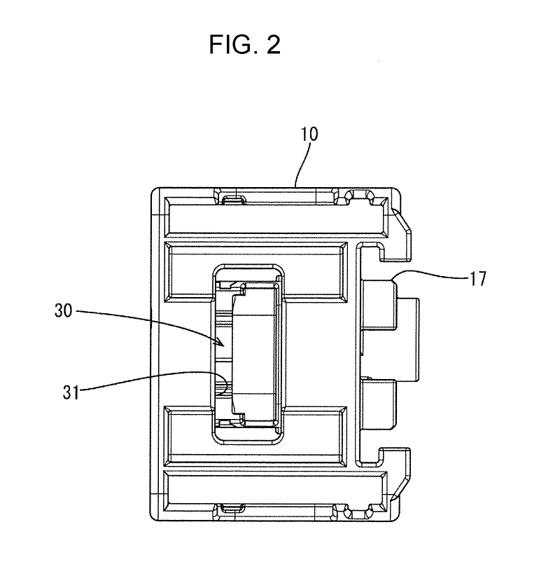

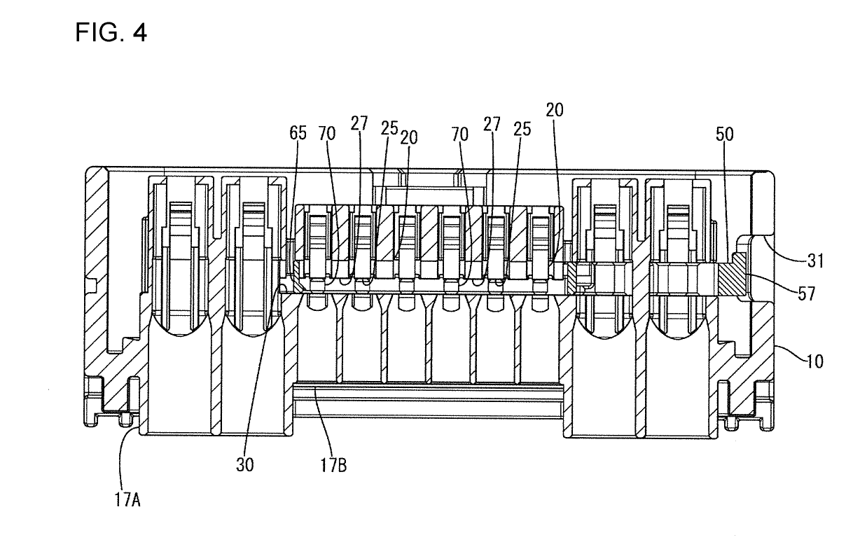

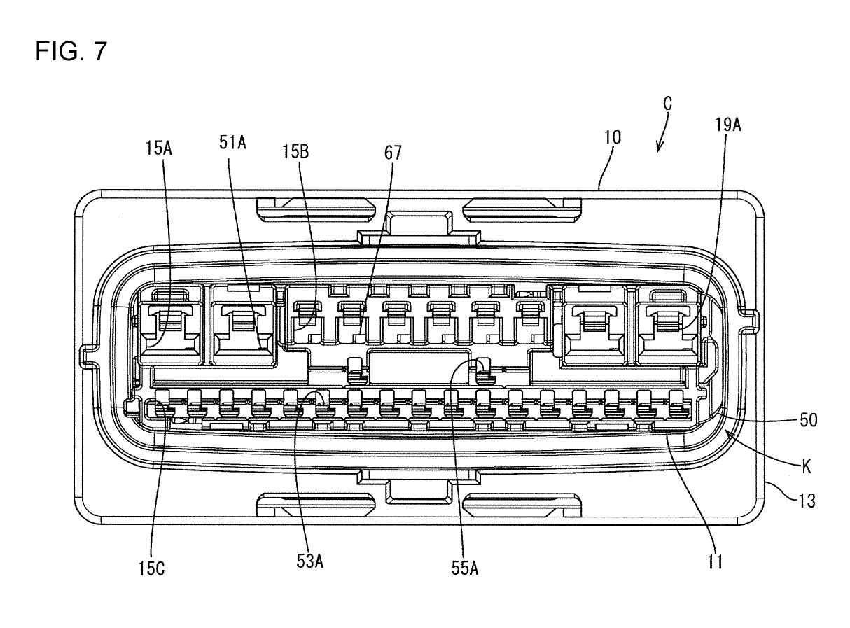

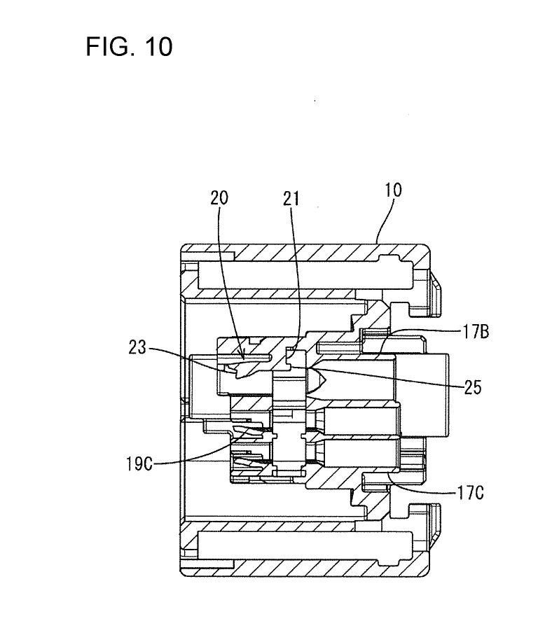

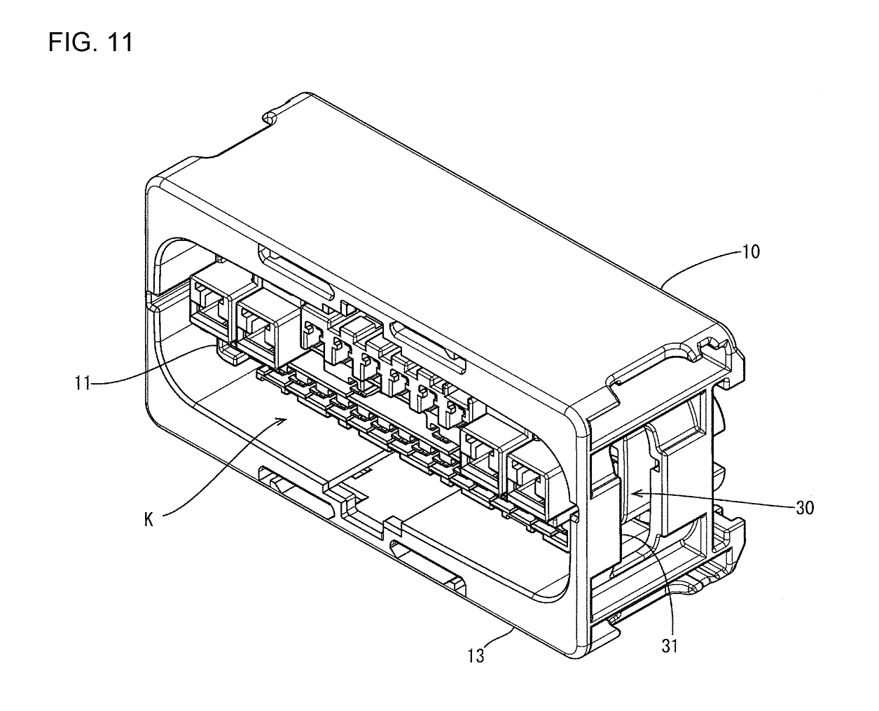

An embodiment is described with reference to FIGS. 1 to 16.

A connector C of this embodiment includes a female connector housing 10 and a side retainer 50 to be mounted into the connector housing 10 as shown in FIG. 1. In the following description, a connecting direction and a separating direction of the connector C and a mating connector are referred to as a forward direction and a rearward direction concerning a front-rear direction, and a vertical direction is based on FIG. 1.

The connector housing 10 is made of synthetic resin and shaped to be long in a lateral direction. Further, as shown in FIG. 1, the connector housing 10 includes a connector housing body 11 formed with cavities 15 capable of accommodating terminal fittings, and an outer peripheral portion 13 in the form of a rectangular tube provided on the outer periphery of the connector housing body 11. A connection space K into which the mating connector is inserted at the time of connection is defined between the connector housing body 11 and the outer peripheral portion 13.

The cavity 15 is provided in the connector housing body 11 and open in the connecting direction (both forward and rearward directions). The terminal fitting is insertable into the cavity 15 from behind (side opposite to a connection surface), and a mating terminal fitting accommodated in the mating connector is insertable into the cavity 15 from front, i.e. from the side of the connection surface. As shown in FIG. 1, three types of cavities 15 differing in size are mixedly provided, large-size cavities 15A are arranged side by side in upper parts of both end parts of a long side (lateral direction) of the connector housing body 11, and a plurality of medium-size cavities 15B for accommodating medium-size terminal fittings are arranged in an area between these large-size cavities 15A. Further, a plurality of small-size cavities 15C for accommodating small-size terminal fittings are arranged below the medium-size and large-size cavities 15B, 15A. Note that, in the following description, the cavities 15A to 15C are referred to as the cavities 15 when a common configuration is described.

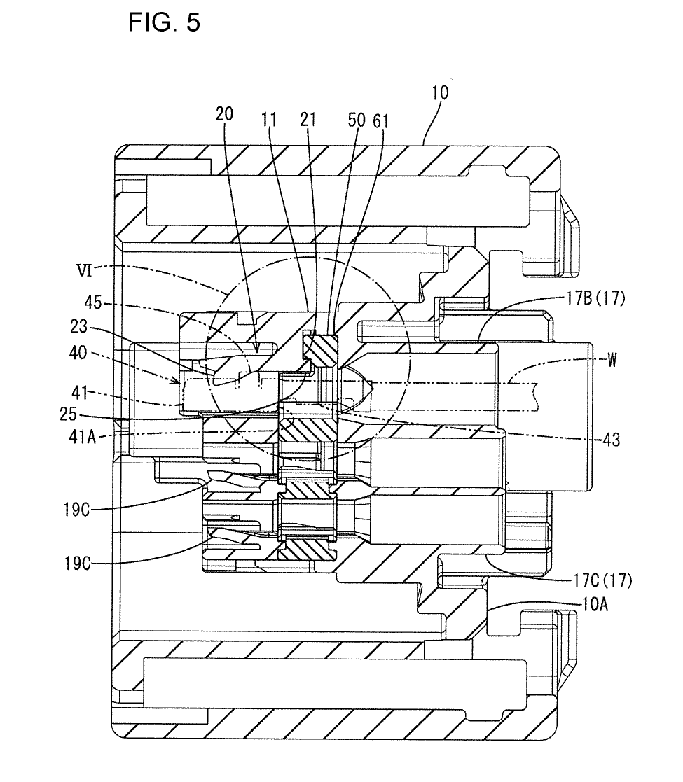

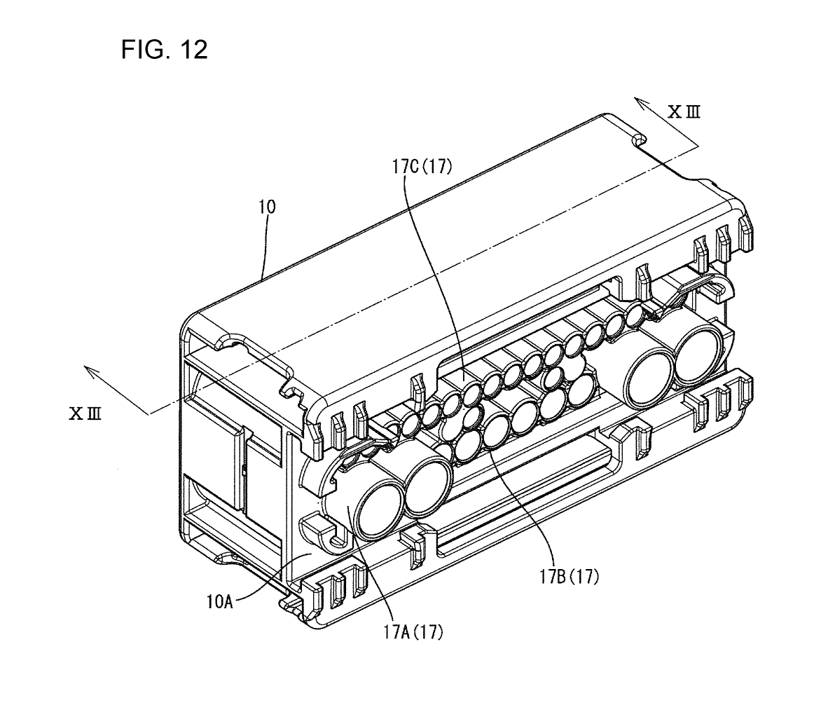

As shown in FIGS. 5, 12 and the like, cylindrical wire accommodating tubes 17 are provided to project from a rear surface 10A of the connector housing 10 at positions corresponding to the positions of the cavities 15. The inner surface of the wire accommodating tube 17 is provided to be widened from and continuous with that of the cavity 15. Similarly to the cavities 15, three types of wire accommodating tubes 17 differing in size are also mixedly provided, and the wire accommodating tubes 17A to 17C are provided in accordance with the respective cavities 15A to 15C.

As shown in FIG. 1 and the like, a large-size locking lance 19A for primarily locking the large-size terminal fitting is provided to be deflectable and deformable upwardly on the ceiling surface of each large-size cavity 15A. Further, as shown in FIGS. 1, 5 and the like, a small-size locking lance 19C for primarily locking the small-size terminal fitting is provided to be deflectable and deformable downwardly on the bottom surface of each small-size cavity 15C. Furthermore, a cantilevered medium-size locking lance 20 is provided on the ceiling surface of the medium-size cavity 15B.

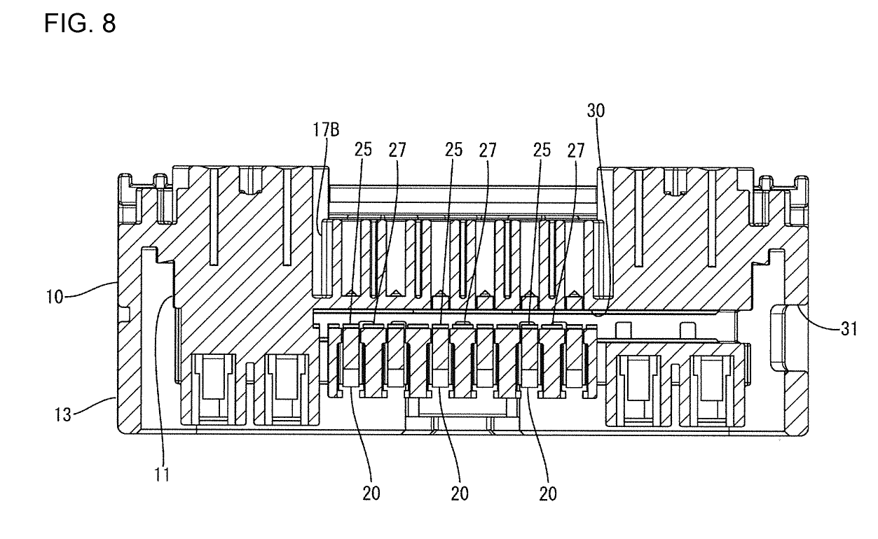

As shown in FIG. 5, the medium-size locking lance 20 includes a base end portion 21 continuous with the ceiling surface of the medium-size cavity 15B, a lance locking portion 23 provided to be deflectable and deformable forwardly of the base end portion 21 and a projection 25 flush with the lower surface of the lance locking portion 23 and projecting rearward from the base end portion 21. The lance locking portion 23 primarily locks the medium-size terminal fitting 40 by locking a connecting portion 41 of the medium-size terminal fitting 40 to be described later. As shown in FIG. 8, the projection 25 has the same width as the lance locking portion 23 and the base end portion 21. By providing the projection 25 continuous with the medium-size locking lance 20 in this way, the rigidity of the medium-size locking lance 20 is improved. Note that the base end portion 21 of the medium-size locking lance 20 is provided behind the base end of the medium-size locking lance 19C.

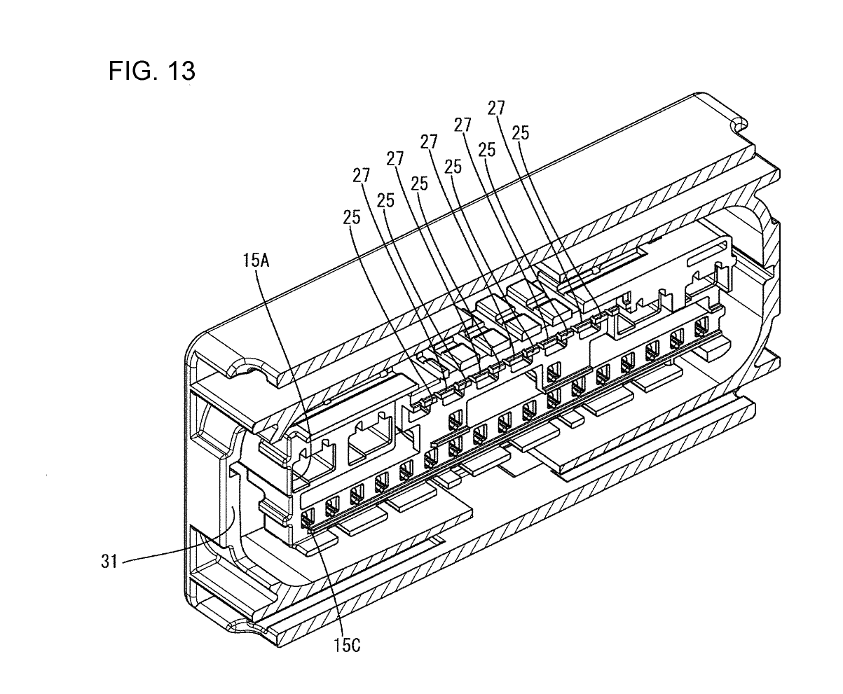

As shown in FIGS. 8 and 13, separation wall projections 27 are provided between a plurality of projections 25 on a wall surface facing the retainer insertion opening 30 to be described later with tiny clearances defined between the separation wall projections 27 and the projections 25. The separation wall projection 27 is provided to project rearward from a separation wall provided between the medium-size cavities 15B. Further, the separation wall projection 27 is provided to have the same rearward projecting dimension and projecting height as the projection 25 of the medium-size locking lance 20.

As shown in FIG. 5, the medium-size terminal fitting 40 includes the connecting portion 41 in the form of a rectangular tube to be connected to a mating terminal, and crimped to an end of a wire W by swaging a barrel 43 at a rear end. The connecting portion 41 is formed with a locked portion to which the medium-size locking lance 20 is lockable, and a rear edge 41A of the lower surface of the connecting portion 41 is lockable to the side retainer 50 to be described later. Further, the connecting portion 41 is provided with posture holding portions 45 for holding an insertion posture of the medium-size terminal fitting 40, and these posture holding portions 45 pass along both sides of the base end portion 21 of the medium-size locking lance 20.

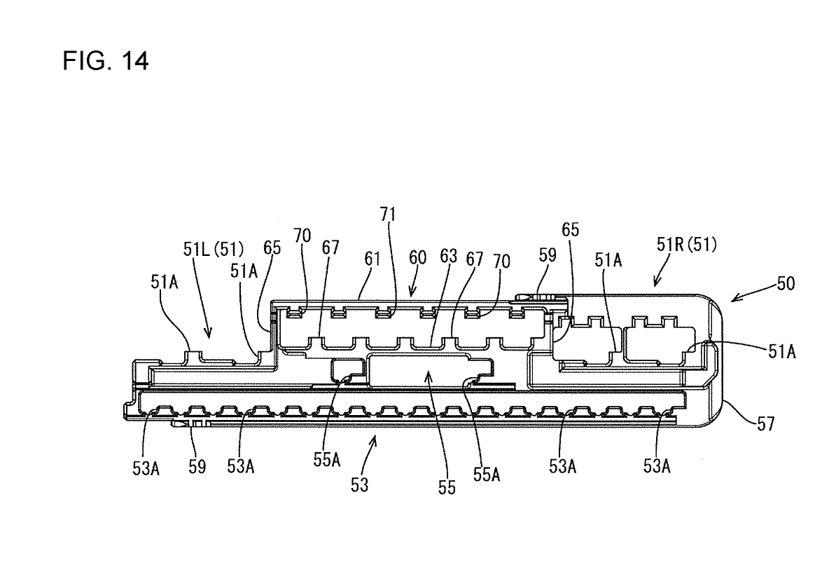

The side retainer 50 for doubly locking each terminal fitting is mountable into the connector housing 10. This side retainer 50 is made of synthetic resin and roughly has a substantially rectangular shape long in the lateral direction as shown in FIGS. 14 to 16. The side retainer 50 includes large-size terminal locking portions 51 provided on upper parts of both left and right ends, a first small-size terminal locking portion 53 provided on a lower part, a second small-size terminal locking portion 55 provided above the first small-size terminal locking portion 53 and between the left and right large-size terminal locking portions 51, and a medium-size terminal locking portion 60 provided between the left and right large-size terminal locking portions 51 on an uppermost part.

The left and right large-size terminal fitting locking portions 51 have different shapes in FIG. 14, the left large-size terminal locking portion 51 of FIG. 14 is denoted by 51L and the right large-size terminal locking portion 51 of FIG. 14 is denoted by 51R. The left large-size terminal locking portion 51L has only a lower part and is shaped in conformity with the shape of the lower surfaces of the large-size cavities 15A. Large-size terminal locking protrusions 51A are provided on right sides of parts corresponding to the respective large-size cavities 15A. These large-size terminal locking protrusions 51A secondarily lock the large-size terminal fittings when the side retainer 50 is at a full locking position. Holes are open on the right large-size terminal locking portion 51 to correspond to the respective large-size cavities 15A, and the large-size terminal locking protrusions 51A are provided on right sides of these holes.

First small-size terminal locking protrusions 53A for locking the small-size terminal fittings are formed at the same intervals as the small-size cavities 15C on a laterally extending bottom piece of the first small-size terminal locking portion 53. An arm portion is provided between the first and second small-size terminal locking portions 53 and 55, and vertical frame pieces are provided on both left and right sides between this arm portion and the bottom piece. Holes are open on the second small-size terminal locking portion 55 at positions corresponding to the small-size cavities 15C and second small-size terminal locking protrusions 55A are provided on right sides of these holes.

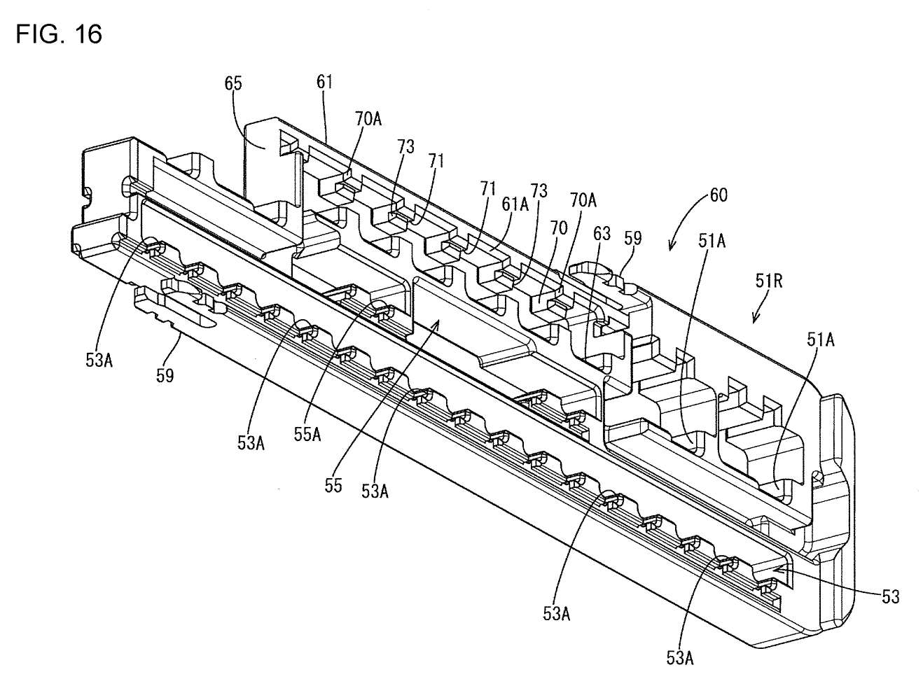

As shown in FIGS. 14 and 16, the medium-size terminal locking portion 60 extends in the lateral direction and includes a thin plate portion 61 thin in the vertical direction, a bottom plate portion 63 serving as a boundary between the second small-size terminal locking portion 55 and the medium-size terminal locking portion 60, side wall portions 65 linking the thin plate portion 61 and the second small-size terminal locking portion 55 and convex portions 70 provided on the lower surface of the thin plate portion 61. Further, medium-size terminal locking protrusions 67 for locking the rear edges 41A of the lower surfaces of the connecting portions 41 of the medium-size terminal fittings 40 are formed at the same intervals as the medium-size cavities 15B on the bottom plate portion 63.

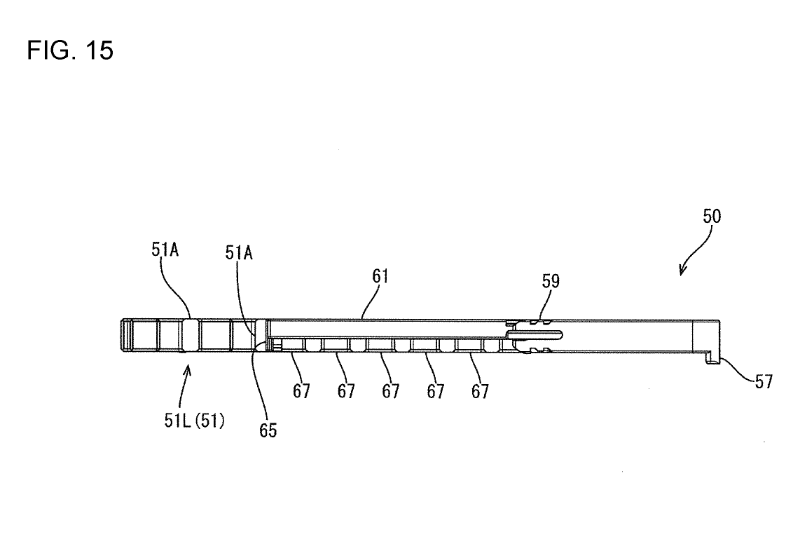

As shown in FIGS. 5 and 15, a dimension in the front-rear direction of the thin plate portion 61 (dimension in an inserting direction of the terminal fittings) is substantially about half those of the other parts of the side retainer 50. The thin plate portion 61 has such a dimension in the front-rear direction because the rear ends of the medium-size locking lances 20 are arranged at the same height position as the thin plate portion 61 in the vertical direction and the medium-size locking lances 20 extend more rearward than the small-size locking lances 19C. Thus, out of the side retainer 50, the thin plate portion 61 is easily deflected downwardly by its own weight. Further, the lower edge of a front end part of the thin plate portion 61 is formed into an inclined surface 61 as shown in FIG. 16.

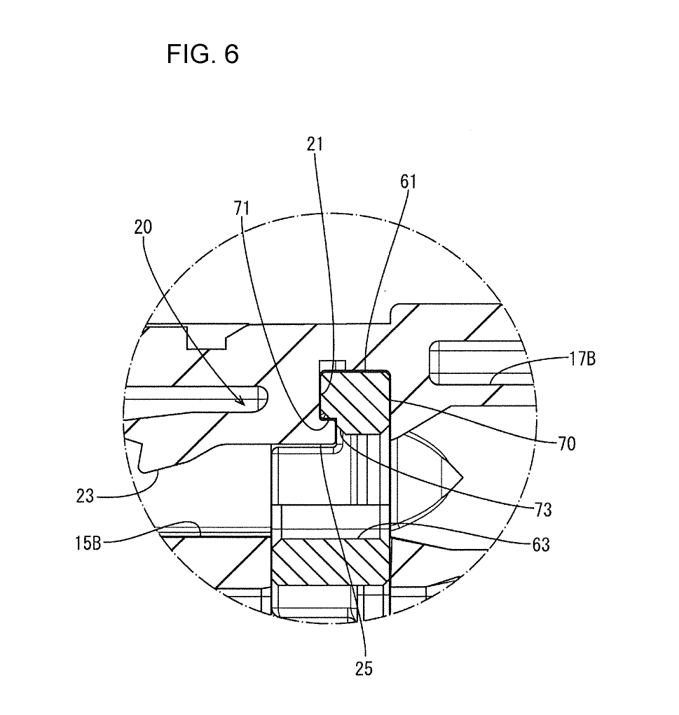

As shown in FIGS. 14 and 16, the convex portions 70 provided on the lower surface of the thin plate portion 61 have the same dimension in the front-rear direction as the thin plate portion 61. The convex portions 70 are arranged between the medium-size terminal locking protrusions 67. Further, as shown in FIGS. 5 and 6, the lower end position of the convex portion 70 is slightly above the lower end position of the medium-size locking lance 20 and the upper end position of the inner surface of the wire accommodating tube 17B. The convex portions 70 project downward from the thin plate portion 61 in this way, whereby the convex portions 70 function as a ceiling surface in the retainer insertion opening 30 to be described later. Further, as shown in FIG. 16, the right side surface of a front end upper portion 70A of the convex portion 70 is formed into such an inclined surface narrowed toward the front, and the lower surface thereof is formed into an inclined surface parallel to the inclined surface 61A of the thin plate portion 61.

Further, as shown in FIGS. 6 and 16, a groove portion 71 is provided by rectangularly cutting a corner part between the front and lower surfaces of the convex portion 70. A tapered portion 73 is provided behind the groove portion 71. The tapered portion 73 is provided on a front side of a lower part of the convex portion 70 where the groove portion 71 is formed, and the left and right side surfaces and lower surface thereof are formed into inclined surfaces to become smaller toward the front end surface. The groove portion 71 is engageable with the projection 25 at a partial locking position of the side retainer 50, and engageable with the separation wall projection 27 at the full locking position of the side retainer 50 (see FIGS. 13 and 16).

Note that an operating portion 57 used to insert and withdraw the side retainer 50 is formed on the right end of the side retainer 50 in FIG. 14. Further, retainer locking portions 59 provided with locking grooves for locking at the partial locking position and the full locking position with respect to the connector housing 10 are provided on an upper end part and a lower end part of the side retainer 50.

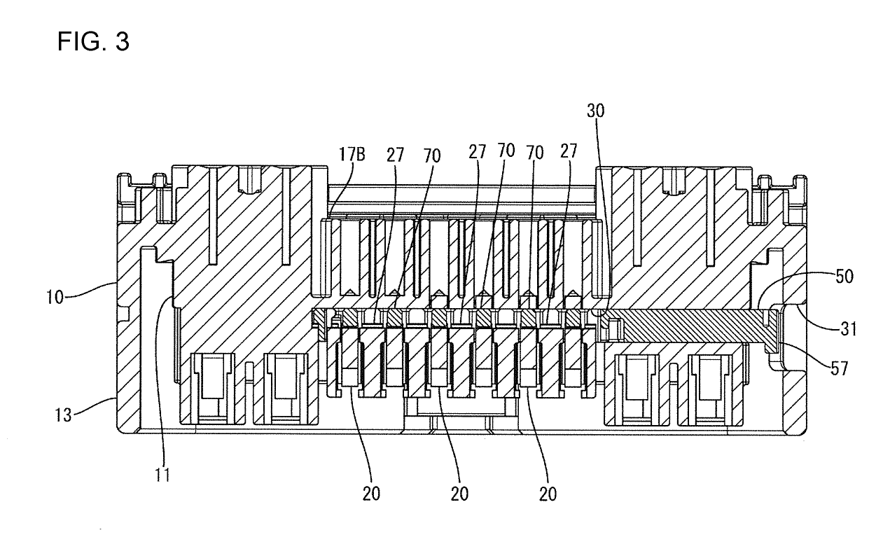

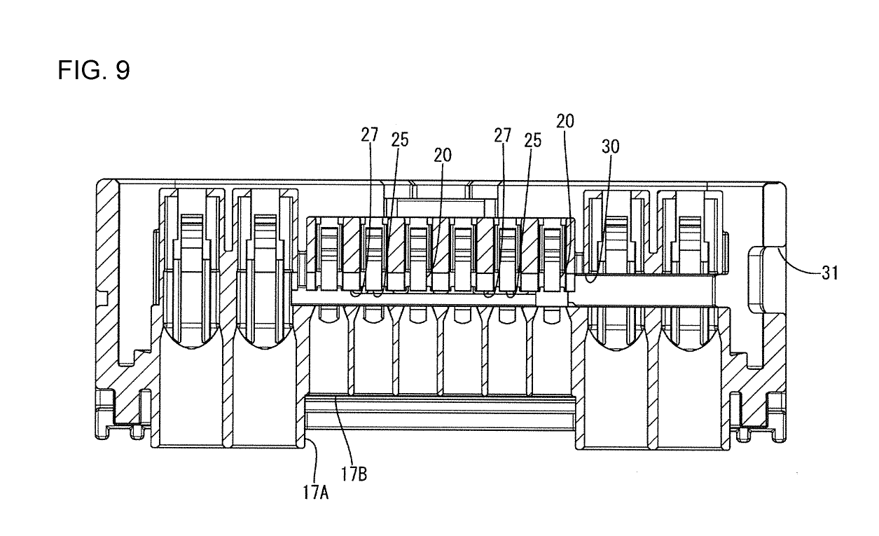

On the other hand, the retainer insertion opening 30 into which the side retainer 50 described above is insertable is formed at an intermediate position of the connector housing 10 in the front-rear direction, specifically slightly behind a position where the locking lances 19A, 19C and 20 are formed, to cross in a direction intersecting with the inserting direction of the terminal fittings as shown in FIGS. 3 and 9. An entrance 31 is open on a right side of the retainer insertion opening 30 when viewed from front.

This embodiment is structured as described above. Next, a mounting procedure of the side retainer 50 and the like are described. The side retainer 50 is inserted through the entrance 31 of the retainer insertion opening 30. At this time, since the front end upper portions 70A and the tapered portions 73 of the convex portions 70 of the side retainer 50 have the inclined surfaces, the inclined surfaces serve as guides for the projections 25 and the separation wall projections 27, whereby the side retainer 50 is smoothly inserted. When the pushing of the side retainer 50 approaches a final stage, the retainer locking portions 59 are locked at the partial locking position inside the retainer insertion opening 30, whereby the side retainer 50 is temporarily held at the partial locking position. At this partial locking position, each locking protrusion 51A, 53A, 55A, 67 is retracted before the corresponding cavity 15. Further, the groove portion 71 of the convex portion 70 is fit to the projection 25 as shown in FIG. 6. By fitting the groove portion 71 to the projection 25 in this way, it is suppressed that the thin plate portion 61 is deflected by its own weight to be curved and deformed.

After the side retainer 50 is held at the partial locking position in this way, the terminal fittings are mounted. The medium-size terminal fitting 40 is inserted into the corresponding medium-size wire accommodating tube 17B, passed through the retainer insertion opening 30 and inserted into the cavity 15B. At this time, since the convex portions 70 of the side retainer 50 are provided in the retainer insertion opening 30, it is suppressed that the medium-size terminal fitting 40 is inclined upwardly during the insertion of the medium-size terminal fitting 40, and the medium-size terminal fitting 40 is smoothly inserted into the cavity 15B. Further, since spaces are provided between the projections 25 and the separation wall projections 27, the posture holding portions 45 of the medium-size terminal fitting 40 can pass through. When the medium-size terminal fitting 40 is pushed to a predetermined position while deflecting and deforming the medium-size locking lance 20, the medium-size locking lance 20 is restored and locks in the connecting portion 41, whereby the medium-size terminal fitting 40 is primarily locked. The large-size and small-size terminal fittings are also similarly inserted into the corresponding wire accommodating tubes 17 and cavities 15 from behind and the large-size and small-size locking lances 19A, 19C resiliently lock to primarily lock the large-size and small-size terminal fittings.

After the insertion of all the terminal fittings is completed, the side retainer 50 is further pushed from the partial locking position and the retainer locking portions 59 are locked at the full locking position, whereby the side retainer 50 is held at the full locking position. At this full locking position, each locking protrusion 51A, 53A, 55A, 67 is inserted in the corresponding cavity 15 and arranged behind the connecting portion of each terminal fitting, whereby each terminal fitting is retained and doubly locked. Further, the groove portions 71 of the convex portions 70 are fit to the separation wall projections 27. By fitting the groove portions 71 to the separation wall projections 27 also at the full locking position in this way, it is suppressed that the thin plate portion 61 is deflected by its own weight to be curved and deformed.

As described above, in this embodiment, the groove portions 71 are formed in the convex portions 70 provided on the thin plate portion 61 of the side retainer 50 and, on the other hand, the projections 25 and the separation wall projections 27 are respectively provided along an inserting direction of the side retainer 50 on the medium-size locking lances 20 and the wall surface facing the retainer insertion opening 30, and the groove portions 71 and the projections 25, the separation wall projections 27 are fit to each other. Thus, despite a thin and long shape of the thin plate portion 61, it is suppressed that the thin plate portion 61 is deflected to be curved and deformed.

### Other Embodiments

The technique disclosed in this specification is not limited to the above described and illustrated embodiment. For example, the following mode is also included.

(1) Although the thin plate portion 61 has a smaller dimension in the front-rear direction than the other parts of the side retainer 50 in the above embodiment, the thin plate portion 61 may have the same dimension as the other parts.

### LIST OF REFERENCE SIGNS

10 . . . connector housing
11 . . . connector housing body
15 (15A to 15C) . . . cavity
20 . . . medium-size lance
25 . . . projection
27 . . . separation wall projection
30 . . . retainer insertion opening
40 . . . medium-size terminal fitting
41 . . . connecting portion
41A . . . rear edge of lower surface of connecting portion
45 . . . posture holding portion
50 . . . side retainer
51 (51R, 51L) . . . large-size terminal locking portion
53 . . . first small-size terminal locking portion
55 . . . second small-size terminal locking portion
60 . . . medium-size terminal locking portion
61 . . . thin plate portion
67 . . . medium-size terminal locking protrusion
70 . . . convex portion
71 . . . groove portion
C . . . connector

1. A connector, comprising:
a connector housing provided with a cavity, into which a terminal fitting is to be insertable, a locking lance provided in the cavity and configured for primarily locking the terminal fitting inserted into the cavity, the connector housing being connectable to a mating connector;
a retainer insertion opening provided in a side surface of the connector housing and open in a direction intersecting with an inserting direction of the terminal fitting; and
a retainer to be inserted into the retainer insertion opening to lock the terminal fitting,
wherein:
the retainer includes a thin plate extending in an inserting direction of the retainer, a convex portion provided on a lower surface of the thin plate and a groove provided in the convex portion; and
a projection provided on a rear end part of the locking lance in the cavity of the connector housing and being configured to fit to the groove.

2. The connector of claim 1, wherein:
the cavity is a first cavity, and the connector housing is formed with a plurality of further cavities such that terminal fittings of two or more sizes are arranged in a plurality of stages;
a rear end part of the locking lance for locking a large-size terminal fitting larger than a smallest terminal fitting projects more toward the retainer than the locking lances for locking the other terminal fittings; and
a dimension of the thin plate in the inserting direction of the terminal fittings is smaller than that of other parts of the retainer in the inserting direction of the terminal fittings to avoid the locking lance for locking the large-size terminal fitting.
